(19) United States
(12) Patent Application Publication
(10) Pub. No.: US 2004/0017378 A1
(43) Pub. Date: Jan. 29, 2004

(54) Overlay processing device and method

(76) Inventors: Chi-Yang Lin, Taipei (TW); Titan Sun, Hsinchu (TW); Daniel Chen, Hsinchu (TW); Stam Chuang, Hsinchu (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/616,338

(22) Filed: Jul. 9, 2003

(30) Foreign Application Priority Data
Jul. 25, 2002 (TW) 091116627

(51) Int. Cl. G09G 5/02; G09G 5/00; G06F 13/00

(52) U.S. Cl. 345/592; 345/629; 345/536

(57) ABSTRACT

An overlay frame processing method and device are used for showing a display frame and an overlay frame outputted by a digital image processing device on a display. The display frame and the overlay frame respectively consist of display frame pixel data and overlay frame pixel data at corresponding positions. A display controller and an overlay engine read and transmit the display frame pixel data and the overlay frame pixel data out, respectively. An alpha-blending engine receives and performs an alpha-blending operation on the display frame pixel data and the overlay frame pixel data to obtain an alpha-blended pixel data. A digital-to-analog converter converts the alpha-blended pixel data into an analog signal and transmits the analog signal to the display to be displayed.

### FIELD OF THE INVENTION

The present invention relates to an overlay processing device, and more particular to a device for alpha-blending an overlay frame. The present invention also relates to a method for alpha-blending an overlay frame.

### BACKGROUND OF THE INVENTION

Please refer to FIG. 1 that is a schematic diagram showing a well known processing scheme for processing output image signals in a computer system. In a memory 10, an on-screen frame buffer 101 is arranged to store pixel data. The pixel data are sequentially transmitted to a digital-to-analog converter (DAC) 12 via a cathode-ray-tube controller (CRTC) 11 to be properly converted. Then, a desired frame is shown on a display 15. In the scheme as shown, an overlay engine 13 and an overlay frame buffer 102 arranged in the memory 10 are used to perform overlay-associated functions. The overlay engine 13 reads pixel data from the overlay frame buffer 102 and refers to the pixel data outputted by the CRTC 11 to execute overlay operations. The overlay data are transmitted to the DAC 12 to be converted into analog signals suitable for the operation of the display 15.

Further referring to FIG. 2, an exemplified overlay frame is illustrated. In this example, the pixel data stored in the on-screen frame buffer 101 relate to the background frame 20 in the display. The overlay engine 13 reads pixel data from the overlay frame buffer 102, and replaces them for a defined portion of the pixel data belonging to the background frame 20 but located within the overlay range. The over-lay associated pixel data are then transmitted to the DAC 12 to be converted into analog signals suitable for the operation of the display 15, and shown in the region 21 on the display 15. Due to the overlay effect, the portion of the background frame 20 covered by the overlay frame 21 is invisible. When the user needs to see the hidden portion of the background frame 20, e.g. a shortcut icon in the desktop image frame, he has to make additional effort to move the overlay frame away.

### SUMMARY OF THE INVENTION

Therefore, an objective of the present invention is to provide an overlay processing device and an overlay processing method, which allows the hidden portion of the background frame 20 to be recognized to a certain extent, so as to simplify the user's operation.

A first aspect of the present invention relates to an overlay frame processing method for showing a display frame and an overlay frame outputted by a digital image processing device on a display. The display frame and the overlay frame respectively consist of display fame pixel data and overlay frame pixel data at corresponding positions. The method comprises steps of: performing an alpha-blending operation on the display frame pixel data and the overlay frame pixel data to obtain alpha-blended pixel data; and substituting the alpha-blended pixel data for the overlay frame pixel data to be displayed by the display.

Preferably, the color value C4 of the alpha-blended pixel determined by a formula C4=(1−A1)*C1+A1*C2, where C1 indicates a color value of the display frame pixel data, C2 indicates a color value of the overlay frame pixel data, and A1 indicates an alpha value lying between 0 and 1.

Preferably, the alpha value A1 is one of the parameters included in the display frame pixel data or a preset value.

A second aspect of the present invention relates to an overlay frame processing method, wherein the display frame consists of display frame pixel data, and the first and the second overlay frames consist of first and second overlay frame pixel data. The method comprises steps of: performing an alpha-blending operation on the display frame pixel data and the first overlay frame pixel data of a first pixel point to obtain a first alpha-blended pixel data; performing an alpha-blending operation on the display frame pixel data and the second overlay frame pixel data of a second pixel point to obtain a second alpha-blended pixel data; and displaying the first and the second alpha-blended pixel data at the first and the second pixel points, respectively.

In a case that the first and the second overlay frames overlap with each other to form an overlapped region, the method preferably further comprises steps of: performing an alpha-blending operation on the display frame pixel data and the first and the second overlay frame pixel data of a third pixel point in the overlapped region to obtain a third alpha-blended pixel data; and displaying the third alpha-blended pixel data at the third pixel point.

Preferably, a color value C6 of the third alpha-blended pixel data is determined by a formula

C6=A1*[A2*C2+(1−A2)*C3]+(1−A1)*C1, or

C6=A2*C2+(1−A2)(1−A1)*C3+A1*C1,

where C1 indicates a color value of display frame pixel data in the overlapped region, C2 indicates a color value of overlay frame pixel data in the overlapped region, C3 indicates a color value of overlay frame pixel data in the overlapped region, and A1 and A2 are alpha values lying between 0 and 1.

Preferably, the alpha value A1 is one of the parameters included in the display frame pixel data, and the alpha value A2 is a preset value.

Alternatively, both the alpha values A1 and A2 are preset values.

A third aspect of the present invention relates to an overlay frame processing device for showing a display frame and an overlay frame outputted by a digital image processing device on a display. The display frame and the overlay frame respectively consist of display frame pixel data and overlay frame pixel data at corresponding positions. The device comprises a display controller reading and transmitting the display frame pixel data; an overlay engine reading and transmitting the overlay frame pixel data; an alpha-blending engine in communication with the display controller and the overlay engine, receiving and performing an alpha-blending operation on the display frame pixel data and the overlay frame pixel data to obtain an alpha-blended pixel data; and a digital-to-analog converter in communication with the alpha-blending engine, converting the alpha-blended pixel data into an analog signal and transmitting the analog signal to the display to be displayed.

Preferably, the display frame pixel data and the overlay frame pixel data are stored in a memory of the digital image processing device.

Preferably, the alpha-blending engine realizes an alpha value from the display frame pixel value to perform the alpha-blending operation.

Alternatively, the alpha-blending engine realizes an alpha value from a memory of the digital image processing device to perform the alpha-blending operation.

### DESCRIPTION OF DRAWINGS

The above objects and advantages of the present invention will become more readily apparent to those ordinarily skilled in the art after reviewing the following detailed description and accompanying drawing, in which:

FIG. 1 is a schematic diagram showing a prior art processing scheme for processing output image signals in a computer system;

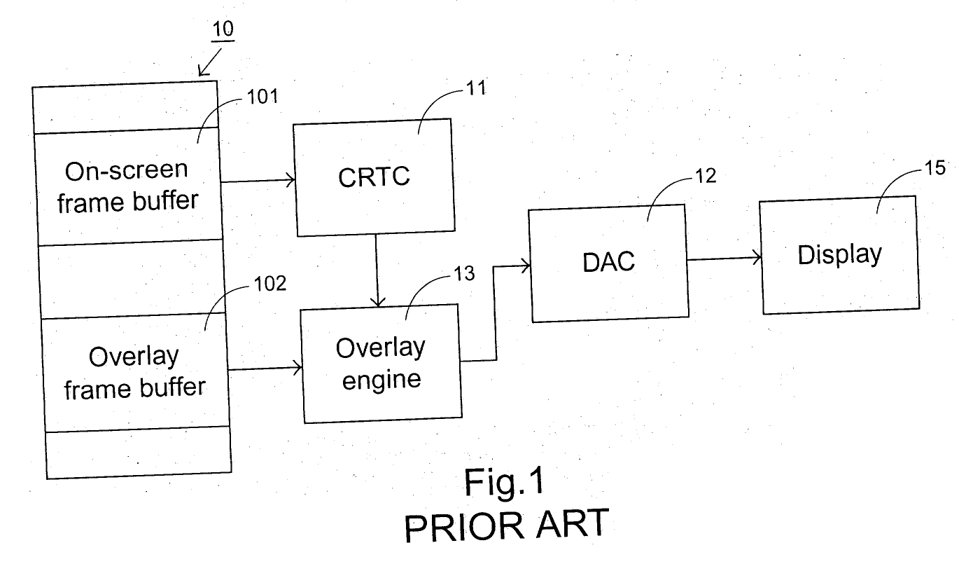

FIG. 2 is a schematic diagram illustrating an exemplified overlay frame according to prior art;

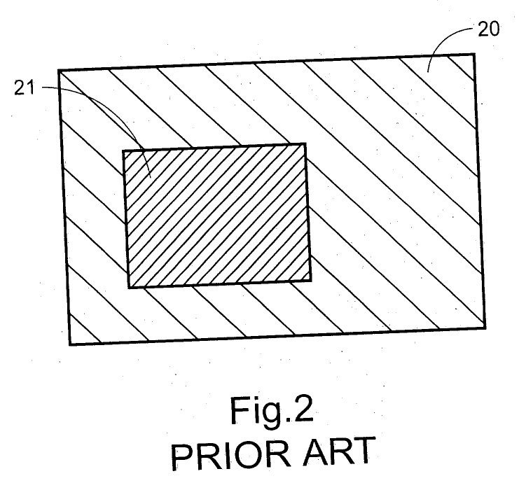

FIG. 3 is a schematic diagram showing a processing scheme for processing output image signals in a computer system according to the present invention;

FIG. 4A is an example of an overlay frame obtained by the processing method of the present invention; and

FIG. 4B is another example of an overlay frame obtained by the processing method of the present invention.

### DETAILED DESCRIPTION OF PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

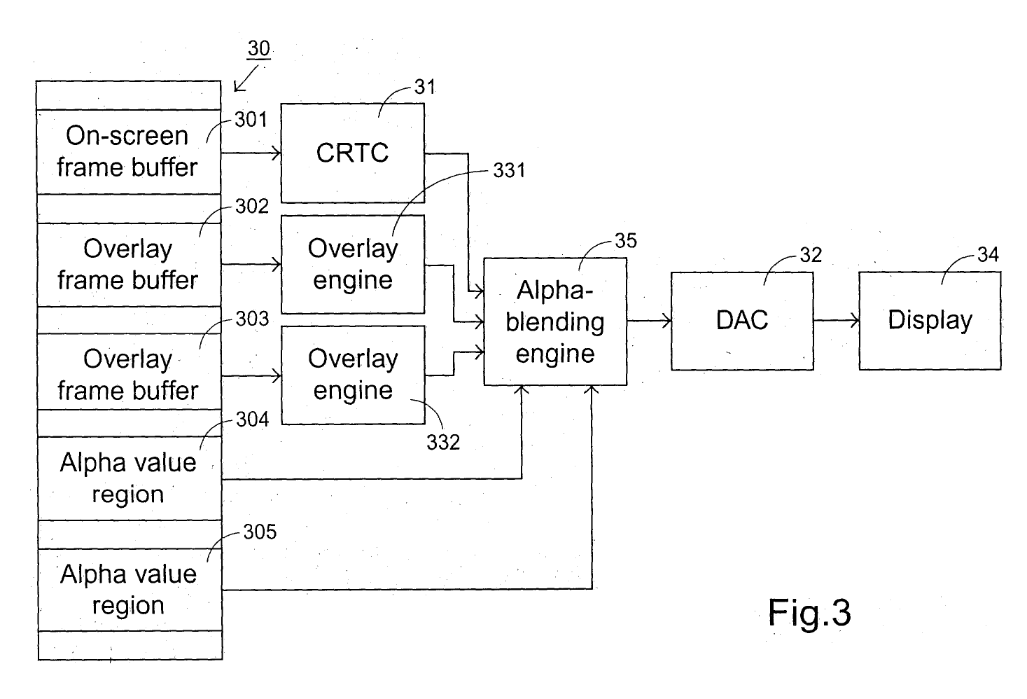

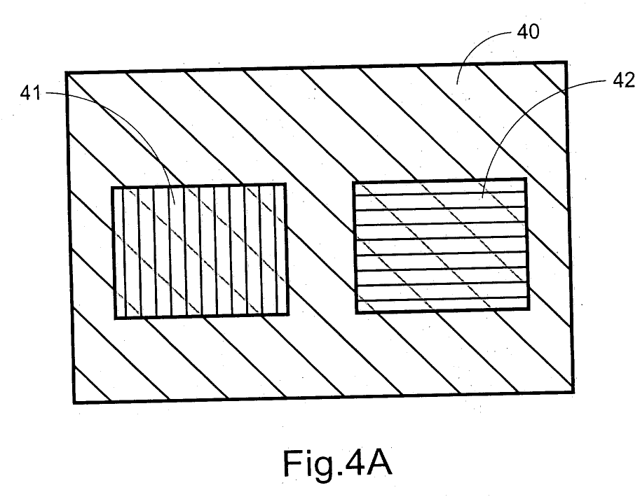

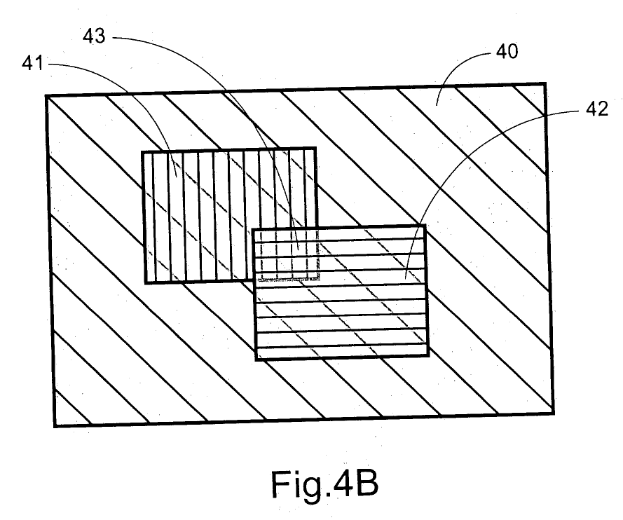

Please refer to FIG. 3. A processing scheme for processing output image signals in a computer system according to the present invention is illustrated. The computer system comprises a memory 30, an overlay processing device and a display 34. The overlay processing device includes a a cathode-ray-tube controller (CRTC) 31, a plurality of overlay engines 331, 332, an alpha-blending engine 35 and a digital-to-analog converter (DAC) 32. In the memory 30, an on-screen frame buffer 301 is arranged to store display frame pixel data to be picked up by the CRTC 31. In addition, the overlay frame buffers 302, 303 are arranged to store respective overlay frame pixel data. The overlay frame pixel data are inputted to the alpha-blending engine 35 along with the display frame pixel data to be processed into alpha-blended pixel data. The alpha blended pixel data are further transmitted to the DAC 32 to be converted into signals suitable for the display 34. Examples will be given with reference to FIGS. 4A and 4B, in which two exemplified display frame and overlay frames are shown, respectively.

In the example shown in FIG. 4A, the display frame pixel data stored in the on-screen frame buffer 301 are picked up by the CRTC 31 and revealed on the display 34 as an original frame 40. Meanwhile, the display frame pixel data are transmitted to the alpha-blending engine 35. On the other hand, the overlay frame pixel data stored in the overlay frame buffers 302 and 303 are picked up by respective overlay engines 331 and 332, and then transmitted to the alpha-blending engine 35. In the alpha-blending engine 35, display frame pixel data and overlay frame pixel data at corresponding positions are operated by alpha blending so as to show overlay frames 41 and 42 with alpha-blending effect. For example, the color value of the alpha-blended pixel data C4=(1−A1)*C1+A1*C2 is given for the overlay from 41, where C1 indicates the color value of the display frame pixel data stored in the on-screen frame buffer 301, C2 indicates the color value of the overlay frame pixel data stored in the overlay frame buffer 302, and A1 indicates an alpha value lying between 0 and 1. The alpha value A1 can be obtained from the parameters A (alpha value), R (red pixel value), G (green pixel value) and B (blue pixel value) of the display frame pixel data stored in the on-screen frame buffer 301. Alternatively, the alpha value A1 can be preset by an application program and stored in a specified region 304 of the memory 30. Likewise, the color value of the alpha-blended pixel data C5=(1A2)*C1+A2* C3 is given for the overlay frame 42, where C1 indicates the color value of the display frame pixel data stored in the on-screen frame buffer 301, C3 indicates the color value of the overlay frame pixel data stored in the overlay frame buffer 303, and A2 indicates an alpha value lying between 0 and 1. The alpha value A2 can also be obtained from the parameters A (alpha value), R (red pixel value), G (green pixel value) and B (blue pixel value) of the display frame pixel data stored in the on-screen frame buffer 301. Alternatively, the alpha value A2 can be preset by an application program and stored in a specified region 305 of the memory 30.

By this way, the original frame 40, even if covered by the overlay frames 41 and 42, can still be recognized to a certain extent due to the alpha blending effect.

In the example shown in FIG. 4B, the overlay frames 41 and 42, each partially covering the original frame 40, further overlap with each other, and an overlapped region 43 is caused. After being processed by the alpha-blending engine 35, the color values C4, C5 and C6 of the pixel points in the frames 41, 42 (except the region 43) and the overlapped region 43 are obtained by the following formulae:

C4=(1−A1)*C1+A1*C2;

C5=(1−A2)*C1+A2*C3; and

c6=A1*[A2*C2+(1−A2)*C3]+(1−A1)*C1, or A2*C2+(1−A2)(1−A1)*C3+A1*C1,

where C1 indicates the color value of the display frame pixel data stored in the on-screen frame buffer 301, C2 indicates the color value of the overlay frame pixel data stored in the overlay frame buffer 302, C3 indicates the color value of the overlay frame pixel data stored in the overlay frame buffer 303, A1 lying between 0 and 1 indicates an alpha value reading from the alpha value region 304 or derived from the parameters of the display frame pixel data stored in the on-screen frame buffer 301, and A2 lying between 0 and 1 indicates an alpha value reading from the alpha value region 305.

By this way, the original frame 40 covered by the overlay frames 41 and 42 and even the overlapped region 43, can still be recognized to a certain extent due to the alpha blending effect.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An overlay frame processing method for showing a display frame and an overlay frame outputted by a digital image processing device on a display, said display frame and said overlay frame respectively consisting of display frame pixel data and overlay frame pixel data at corresponding positions, said method comprising steps of:
performing an alpha-blending operation on said display frame pixel data and said overlay frame pixel data to obtain an alpha-blended pixel data; and
substituting said alpha-blended pixel data for said overlay frame pixel data to be displayed by said display.

2. The method according to claim 1 wherein a color value C4 of said alpha-blended pixel data is determined by a formula C4 (1−A1)*C1+A1*C2, where C1 indicates a color value of said display frame pixel data, C2 indicates a color value of said overlay frame pixel data, and A1 indicates an alpha value lying between 0 and 1.

3. The method according to claim 2 wherein said alpha value A1 is one of the parameters included in said display frame pixel data.

4. The method according to claim 2 wherein said alpha value A1 is a preset value.

5. An overlay frame processing method for showing a display frame and a first and a second overlay frames outputted by a digital image processing device on a display, said display frame and said first and said second overlay frames respectively consisting of display frame pixel data and first and second overlay frame pixel data, said method comprising steps of:
performing an alpha-blending operation on said display frame pixel data and said first overlay frame pixel data of a first pixel point to obtain a first alpha-blended pixel data;
performing an alpha-blending operation on said display frame pixel data and said second overlay frame pixel data of a second pixel point to obtain a second alpha-blended pixel data; and
displaying said first and said second alpha-blended pixel data at said first and said second pixel points, respectively.

6. The method according to claim 5 wherein a color value C4 of said first alpha-blended pixel data is determined by a formula C4=(1−A1)*C1+A1*C2, where C1 indicates a color value of said first display frame pixel data, C2 indicates a color value of said first overlay frame pixel data, and A1 indicates an alpha value lying between 0 and 1.

7. The method according to claim 5 wherein a color value C5 of said second alpha-blended pixel data is determined by a formula C5 (1−A2)*C1+A2*C3, where C1 indicates a color value of said second display frame pixel data, C3 indicates a color value of said second overlay frame pixel data, and A2 indicates an alpha value lying between 0 and 1.

8. The method according to claim 5 wherein said first and said second overlay frames overlap with each other to form an overlapped region, and said method further comprises steps of:
performing an alpha-blending operation on said display frame pixel data and said first and said second overlay frame pixel data of a thid pixel point in said overlapped region to obtain a third alpha-blended pixel data; and
displaying said third alpha-blended pixel data at said third pixel point.

9. The method according to claim 8 wherein a color value C6 of said third alpha-blended pixel data is determined by a formula C6=A1*[A2*C2+(1−A2)*C3]+(1−A1)*C1, or C6 A2*C2+(1−A2)(1−A1)*C3+A1*C1,
where C1 indicates a color value of display frame pixel data in said overlapped region, C2 indicates a color value of overlay frame pixel data in said overlapped region, C3 indicates a color value of overlay frame pixel data in said overlapped region, and A1 and A2 are alpha values lying between 0 and 1.

10. The method according to claim 9 wherein said alpha value A1 is one of the parameters included in said display frame pixel data, and said alpha value A2 is a preset value.

11. The method according to claim 9 wherein said alpha values A1 and A2 are preset values.

12. An overlay frame processing device for showing a display frame and an overlay frame outputted by a digital image processing device on a display, said display frame and said overlay frame respectively consisting of display frame pixel data and overlay frame pixel data at corresponding positions, comprising:
a display controller reading and transmitting said display frame pixel data;
an overlay engine reading and transmitting said overlay frame pixel data;
an alpha-blending engine in communication with said display controller and said overlay engine, receiving and performing an alpha-blending operation on said display frame pixel data and said overlay frame pixel data to obtain an alpha-blended pixel data; and
a digital-to-analog converter in communication with said alpha-blending engine, converting said alpha-blended pixel-data into an analog signal and transmitting said analog signal to said display to be displayed.

13. The device according to claim 12 wherein said display frame pixel data and said overlay frame pixel data are stored in a memory of said digital image processing device.

14. The device according to claim 12 wherein said alpha-blending engine realizes an alpha value from said display frame pixel value to perform said alpha-blending operation.

15. The device according to claim 12 wherein said alpha-blending engine realizes an alpha value from a memory of said digital image processing device to perform said alpha-blending operation.
